(19) United States
(12) Patent Application Publication
(10) Pub. No.: US 2007/0078213 A1
(43) Pub. Date: Apr. 5, 2007

(54) Fine particle hard molded bodies for abrasion-resistant polymer matrices

(76) Inventors: Margarete Mueller, Muenster (DE); Renate Bonn-Walter, Darmstadt (DE); Michael Roesler, Reinheim (DE); Alfred Hennemann, Brombachtal (DE); Marc Entenmann, Fellbach (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/578,726

(22) PCT Filed: Oct. 14, 2004
(86) PCT No.: PCT/EP04/11628

§ 371 Date: May 10, 2006

(30) Foreign Application Priority Data
Nov. 11, 2003 (DE) 103 52 627.7

(51) Int. Cl. C08K 3/34; B32B 19/00

(52) U.S. Cl. 524/449; 524/430; 428/688

(57) ABSTRACT

The invention relates to fine particle hard molded bodies which provide increased abrasion resistance when embedded in polymer matrices. Said fine particle hard molded bodies comprise materials which have a hardness of ≧7 on Mohs' scale of hardness and form the molded body or are provided directly on a fine particle substrate in the form of one or several layers. Also disclosed are a method for producing the molded bodies and the use thereof in polymer matrices.

The present invention relates to finely divided hard moulded bodies whichresult in an increase in the abrasion stability on embedding in polymer matrices, comprising materials having a hardness ≧7 on the Mohs hardness scale which form the moulded body or are present directly on a finely divided substrate as impermeable coating in the form of one or more layers, to processes for the production of these moulded bodies, and to the use thereof in polymer matrices.

The coating of everyday articles with coatings or paints is increasing in importance. The colour effects and the stability of the applied coatings or paints play a special role here. The same applies to plastics, which are likewise frequently intended to be coloured, but are also intended to be distinguished by particular stability. The abrasion of coating layers, for example in cleaning processes, thus represents a severe problem for the use of surface coatings and plastics.

In order to circumvent this problem, U.S. Pat. No. 5,480,931 proposes adding flake-form particles to plastics in order to reduce the visibility of scratches which occur. U.S. Pat. No. 4,123,401 describes compositions comprising fluoropolymers, mica particles or metal flakes and further polymers and liquid vehicles which are intended for use in the coating of metal, in particular of cooking utensils. The mica or metal particles are intended to increase the scratch resistance of the coatings.

It has been found that the above-mentioned solution approaches do not enable sufficient stabilisation of the coatings or plastics, and consequently there continues to be a great demand for abrasion-stable coatings. This applies, in particular, to polymer matrices, such as, for example, powder coatings or industrial coatings for applications in the automobile or building sector, which are subjected to intensive and repeated cleaning processes. At the same time, the increase in the abrasion stability should have no disadvantageous effects on the other properties of the coatings, such as, for example, the colour. The possibility of combining the properties “colour” and “improved abrasion resistance” is the primary aim in this connection.

The object was therefore to find moulded bodies, which result in an increase in the abrasion stability on embedding in polymer matrices.

It has now been found that the finely divided hard moulded bodies according to the invention match the above-mentioned requirement profile.

The present invention accordingly relates to finely divided hard moulded bodies comprising materials having a hardness ≧7 on the Mohs hardness scale which form the moulded body or are present directly on a finely divided substrate as impermeable coating in the form of one or more layers.

The present invention furthermore relates to processes for the production of the finely divided hard moulded bodies according to the invention in which a moulded body is formed from materials having a hardness ≧7 on the Mohs hardness scale or a finely divided substrate is provided with an impermeable coating in the form of one or more layers of materials having a hardness ≧7 on the Mohs hardness scale.

In addition, the present invention likewise relates to the use of the finely divided hard moulded bodies according to the invention in polymer matrices for increasing the abrasion stability.

The moulded bodies according to the invention can be fillers or pigments, preferably pigments. In this way, the advantage of the increase in the abrasion stability can be combined with further advantages, such as, for example, colour or lustre.

The shape of the finely divided hard moulded bodies is not crucial per se and can be matched to the respective circumstances in a manner known to the person skilled in the art. The hardness of the moulded bodies according to the invention is essential here for the improved properties of the polymer matrices to which they are added, in particular the improved abrasion stability. The moulded body or the finely divided substrate are preferably in flake form. Flake-form moulded bodies in accordance with this invention, in particular if they are pigments, have the advantage that particular effects can be achieved using these materials. Thus, interference systems which exhibit a particular lustre, high tinting strength or angle-dependent colours can be applied to the flake-form moulded bodies. This is of particular interest, in particular, in the case of the use of surface coatings, in particular of automobile paints. Flake-form pigments are accordingly particularly preferred as finely divided hard moulded bodies.

The materials having a hardness ≧7 on the Mohs hardness scale can be any known natural or synthetic material which meets this condition, where the hard material can be metallic or non-metallic, for example in the case of corresponding materials from the group of the carbides, nitrides, borides, silicides or oxides. The hard materials are preferably oxides, in particular metal oxides and very particularly preferably aluminium oxide, zirconium oxide and/or mixtures of these materials. It is unimportant here whether the hard material is monocrystalline, microcrystalline or of an amorphous nature. The hardness value relates to the material as pure substance and is usually determined using the scratch method familiar to the person skilled in the art.

In accordance with the present invention, the finely divided hard moulded bodies may themselves consist of materials having a hardness ≧7 on the Mohs hardness scale. In addition, the moulded bodies can be a finely divided substrate provided directly with an impermeable coating in the form of one or more layers of one or more materials having a hardness ≧7 on the Mohs hardness scale, i.e. there are no further interlayers between the substrate and the impermeable coating. The finely divided moulded bodies are preferably substrates provided with an impermeable layer of the hard materials. These can be produced in a simple and inexpensive manner and also allow the large-area use of the moulded bodies. These moulded bodies can frequently be employed further directly for further application of colour systems, such as, for example, interference systems or pigmented layers.

Suitable finely divided substrates are preferably flake-form substrates, for example flake-form TiO₂, synthetic or natural mica, glass flakes, metal flakes, flake-form SiO₂ or flake-form iron oxide. The metal flakes can consist, inter alia, of the elemental metals, such as, for example, aluminium, silver or titanium, but also of mixtures or alloys, such as, for example, bronze or steel, preferably aluminium and/or titanium. The metal flakes here may have been passivated by corresponding treatment. Preference is given to the use of synthetic or natural mica, flake-form SiO₂ or glass flakes as finely divided substrates. The thickness of the substrates is usually between 0.05 and 5 μm, in particular between 0.1 and 4.5 μm.

The size of the finely divided hard moulded bodies is not crucial per se. The thickness of the moulded bodies is generally between 0.05 and 6 μm, in particular between 0.1 and 4.5 μm. If the moulded bodies according to the invention consist of a finely divided substrate provided with an impermeable coating in the form of one or more layers of materials having a hardness ≧7 on the Mohs hardness scale, the thickness of the coating is 40 to 400 nm, preferably 60 to 300 nm and in particular 80 to 200 nm. The length or width dimension of the moulded bodies according to the invention is usually between 1 and 250 μm, preferably between 2 and 200 μm and in particular between 2 and 100 μm.

The moulded bodies according to the invention can be produced in a variety of ways. Thus, the moulded bodies according to the invention are obtainable by wet-chemical application of a precursor to a support, drying, detachment from the support and subsequent calcination with formation of materials having a hardness ≧7on the Mohs hardness scale or by application of materials having a hardness ≧7on the Mohs hardness scale to a support by CVD and/or PVD processes and subsequent detachment from the support, the former production variant being preferred.

Suitable precursors encompass all inorganic or organic compounds known to the person skilled in the art which result in the formation of the moulded bodies under the given conditions. For example, they can be solutions or sols of organic or inorganic compounds, in particular of aluminium or zirconium. The support may consist of a film, a belt or a drum, preferably a continuous belt. Processes of this type are described in WO 93/08237, the disclosure content of which is incorporated herein by way of reference. Subsequent drying causes solidification of the applied precursors, it being possible for a solid matrix of the precursor to develop. The layer obtained in the process is detached from the support and calcined, with the moulded body being formed in the latter step from materials having a hardness ≧7on the Mohs hardness scale. The coating of a support for the production of the moulded bodies according to the invention may also alternatively be carried out by PVD or CVD processes. To this end, materials having a hardness ≧7on the Mohs hardness scale are applied directly to a support by means of these processes, and the moulded body is obtained by detachment from the support. These processes are known from the literature, for example from U.S. Pat. No. 3,123,489.

The moulded bodies according to the invention are furthermore obtainable by wet-chemical precipitation of a primary layer comprising one or more layers on a finely divided substrate and subsequent calcination with formation of an impermeable coating in the form of one or more layers of materials having a hardness ≧7on the Mohs hardness scale on the substrate or by single or repeated coating of a finely divided substrate with materials having a hardness ≧7on the Mohs hardness scale by CVD and/or PVD processes, the former production variant being preferred.

The primary layer can consist of one or more less impermeable and/or hard materials, for example in the case of metal oxides as materials having a hardness ≧7on the Mohs hardness scale, it can consist of corresponding metal hydroxides or metal oxide hydrates. The requisite impermeable and hard coating is then obtained during subsequent calcination. The wet-chemical precipitation can be carried out in all solvents known to the person skilled in the art, preferably in water. In the case of wet coating, the substrates are usually suspended in water, and one or more hydrolysable metal salts are added at a pH which is suitable for hydrolysis and which is selected in such a way that the metal oxides or metal oxide hydrates are precipitated directly onto the substrates without secondary precipitations occurring. The pH is usually kept constant by simultaneous metered addition of a base or acid. Suitable metal salts in the wet-chemical precipitation of the primary layer are all organic or inorganic compounds or salts known to the person skilled in the art, such as, for example, the halides, sulfates, phosphates, carbonates, nitrates or oxalates, in particular those of aluminium and of zirconium. The primary layer may be one layer of a material, but also a plurality of layers of different materials which form the impermeable coating during subsequent calcination. Alternatively, the single or repeated application of materials having a hardness ≧7on the Mohs hardness scale to the finely divided substrate can be carried out by CVD and/or PVD processed, it being up to the person skilled in the art to select suitable processed and starting compounds.

In the case of wet-chemical process variants, the subsequent calcination is an essential part of the process since a sufficiently hard and impermeable material can only be obtained by calcination both in the case of the moulded body according to the invention itself and also in the case of the coating according to the invention applied to a substrate. The calcination is carried out at temperatures of 600 to 1500° C., preferably at temperatures of 800 to 1150° C.

In a preferred embodiment, the moulded bodies according to the invention may furthermore have been coated with one or more transparent, semi-transparent and/or opaque layers comprising metal oxides, metal oxide hydrates, metals, metal suboxides, metal fluorides, metal nitrides, metal oxynitrides or mixtures of these materials. The metal oxide, metal oxide hydrate, metal suboxide, metal, metal fluoride, metal nitride, metal oxynitride layers or the mixtures thereof may be of low refractive index (refractive index <1.8) or high refractive index (refractive index ≧1.8). These layers preferably function as colouring system, where the colour impression may be caused either by absorption or by interference. Suitable metal oxides and metal oxide hydrates are all metal oxides or metal oxide hydrates known to the person skilled in the art, such as, for example, silicon oxide, silicon oxide hydrate, iron oxide, tin oxide, cerium oxide, zinc oxide, chromium oxide, titanium oxide, in particular titanium dioxide, titanium oxide hydrate and mixtures thereof, such as, for example, ilmenite or pseudobrookite. Metal suboxides which can be employed are, for example, the titanium suboxides. Suitable metals are, for example, chromium, aluminium, nickel, silver, gold, titanium, copper or alloys, a suitable metal fluoride is, for example, magnesium fluoride. Metal nitrides or metal oxynitrides which can be employed are, for example, the nitrides or oxynitrides of the metals titanium, zirconium and/or tantalum. Metal oxide, metal, metal fluoride and/or metal oxide hydrate layers and very particularly preferably metal oxide and/or metal oxide hydrate layers are preferably applied to the hard moulded body. It is furthermore also possible for multilayered structures comprising high- and low-refractive-index metal oxide, metal oxide hydrate, metal or metal fluoride layers to be present, preferably with high- and low-refractive-index layers alternating. Particular preference is given to layer packages comprising a high-refractive-index layer and a low-refractive-index layer, where one or more of these layer packages may be applied to the hard moulded body. The sequence of the high- and low-refractive-index layers here can be matched to the hard moulded body in order to include the moulded body in the multilayered structure. In a further embodiment, the metal oxide, metal oxide hydrate, metal suboxide, metal, metal fluoride, metal nitride, metal oxynitride layers may be mixed or doped with colorants or other elements. Suitable colorants or other elements are, for example, organic or inorganic coloured pigments, such as coloured metal oxides, for example magnetite, chromium oxide or coloured pigments, such as, for example, Berlin Blue, ultramarine, bismuth vanadate, Thenard's Blue, or alternatively organic coloured pigments, such as, for example, indigo, azo pigments, phthalocyanines or also Carmine Red, or elements, such as, for example, yttrium or antimony. Application of one or more transparent, semi-transparent and/or opaque layers of the above-mentioned materials to the finely divided hard moulded body is preferred in the present invention. Hard moulded bodies, in particular flake-form ones, comprising these layers exhibit great colour variety with respect to their mass tone and can in many cases exhibit an angle-dependent change in the colour (colour flop) due to interference. The combination of these colour properties with the hardness of the moulded bodies gives rise to particular advantages in the applications, in particular on incorporation into polymer matrices. Thus, besides the increased abrasion stability, a wide latitude in the colour design of the polymer matrices is also created which is not possible with moulded bodies and pigments from the prior art alone. The user is able to select a desired colour effect and is not reliant on the addition of further materials which increase the abrasion stability of polymer matrices.

In a preferred embodiment, the outer layer of the moulded body is a high-refractive-index metal oxide. This outer layer may additionally be on the above-mentioned layer packages or be part of a layer package and consist, for example, of TiO₂, titanium suboxides, Fe₂O₃, SnO₂, ZnO, Ce₂O₃, CoO, Co₃O₄, V₂O₅, Cr₂O₃ and/or mixtures thereof, such as, for example, ilmenite or pseudobrookite. TiO₂ is particularly preferred.

Examples and embodiments of the above-mentioned material combinations and layer structures are given by way of example in the common literature for effect pigments, for example in Research Disclosures RD 471001 and RD 472005, the disclosure content of which is incorporated herein by way of reference.

The thickness of the metal oxide, metal oxide hydrate, metal suboxide, metal, metal fluoride, metal nitride, metal oxynitride layers or a mixture thereof is usually 3 to 300 nm and in the case of the metal oxide, metal oxide hydrate, metal suboxide, metal fluoride, metal nitride, metal oxynitride layers or a mixture thereof preferably 20 to 200 nm. The thickness of the metal layers is preferably 4 to 50 nm.

Furthermore, a further layer of materials having a hardness ≧7on the Mohs hardness scale may additionally have been applied to the above-mentioned transparent, semi-transparent and/or opaque layers. The thickness of the further layer of materials having a hardness ≧7on the Mohs hardness scale can be 20 to 80 nm. These moulded bodies comprise, both in the colouring system and also thereon, hard layers which give rise to an optimum overall hardness of the moulded bodies. Moulded bodies of this type are particularly suitable for increasing the abrasion stability on embedding in polymer matrices.

The present invention likewise relates to processes for the production of the moulded bodies according to the invention in which a moulded body is formed from materials having a hardness ≧7on the Mohs hardness scale or a finely divided substrate provided with an impermeable coating in the form of one or more layers of materials having a hardness ≧7on the Mohs hardness scale. If the moulded body itself consists of a material having a hardness ≧7on the Mohs hardness scale, a precursor is, in accordance with the process of the present invention, applied to a support by wet-chemical methods, dried, detached from the support and subsequently calcined with formation of a moulded body from materials having a hardness ≧7on the Mohs hardness scale, or materials having a hardness 24 7on the Mohs hardness scale are applied to a support by CVD and/or PVD processes and subsequently detached from the support. The suitable precursor, support and conditions have already been mentioned in the description of the moulded bodies.

If the moulded bodies are those which comprise a finely divided substrate having an impermeable coating in the form of one or more layers of materials having a hardness ≧7on the Mohs hardness scale, the process according to the invention for the production thereof is distinguished by the fact that a primary layer comprising one or more layers are precipitated onto a finely divided substrate by wet-chemical methods and calcined with formation of an impermeable coating in the form of one or more layers of materials having a hardness ≧7on the Mohs hardness scale or by the fact that a substrate is coated one or more times with materials having a hardness ≧7on the Mohs hardness scale by CVD and/or PVD processes. Materials which can be employed for the primary layer and conditions for the formation thereof are indicated in the description of the corresponding moulded bodies.

The processes according to the invention can be carried out in a simple manner and allow great variability with respect to the precursors and conditions that can be employed. It is incumbent on the person skilled in the art to match the optimum design of the processes according to the invention to the requisite circumstances.

In a further embodiment of the processes according to the invention, the moulded bodies are additionally coated with one or more transparent, semi-transparent and/or opaque layers comprising metal oxides, metal oxide hydrates, metal suboxides, metals, metal fluorides, metal nitrides, metal oxynitrides or mixtures of these materials. Suitable materials have already been mentioned in the description of the moulded bodies. By means of this process, it is possible to produce lustrous and coloured moulded bodies which provide the polymer matrices into which they are incorporated with particular colour effects. The coating with one or more transparent, semi-transparent and/or opaque layers can be carried out in all ways known to the person skilled in the art, for example by wet-chemical, sol-gel, CVD and/or PVD processes. Coating with these materials is preferably carried out by wet-chemical methods, in the case of metals also preferably by CVD processes. In the case of wet-chemical application, all organic or inorganic compounds of the corresponding metals are suitable, in particular the halides, nitrates, sulfates, carbonates, phosphates or oxalates, the corresponding halides preferably being employed. Processes of this type are described, for example, in DE 14 67 468, DE 19 59 988, DE 20 09 566, DE 22 14 545, DE 22 15 191, DE 22 44 298, DE 23 13 331, DE 25 22 572, DE 31 37 808, DE 31 37 809, DE 31 51 343, DE 31 51 354, DE 31 51 355, DE 32 11 602 or DE 32 35 017. Optimisation of the application conditions is within the expertise of the person skilled in the art. In the case of wet coating, the moulded bodies are usually suspended in water, and one or more hydrolysable metal salts are added at a pH which is suitable for hydrolysis and which is selected so that the metal oxides or metal oxide hydrates are precipitated directly onto the flakes without secondary precipitations occurring. The pH is usually kept constant by simultaneous metered addition of a base or acid. If desired, the moulded bodies can be separated off, dried and optionally calcined after application of individual coatings and then re-suspended again for the precipitation of further layers. In an alternative embodiment, firstly all desired transparent, semi-transparent and/or opaque layers can also be precipitated and subsequently calcined as a whole, usually at temperatures of 600 to 1500° C., preferably at temperatures of 800 to 1150° C.

In a further process according to the invention, a further layer of materials having a hardness ≧7on the Mohs hardness scale is additionally applied to the transparent, semi-transparent and/or opaque layers. All materials mentioned above and all mentioned process variants for their preparation can be employed for the additional layer

The moulded bodies according to the invention can be employed in polymer matrices in which they result in an increase in the abrasion stability. The polymer matrices can be, for example, plastics, paints, coatings or inks. On use of the moulded bodies in coatings and inks, all areas of application known to the person skilled in the art are possible, such as, for example, powder coatings, automobile paints, printing inks for gravure, offset, screen or flexographic printing and for coatings in outdoor applications. The coatings and inks here can be, for example, radiation- curing, physically drying or chemically curing. For the production of printing inks or liquid coatings, a multiplicity of binders is suitable, for example based on acrylates, methacrylates, polyesters, polyurethanes, nitrocellulose, ethylcellulose, polyamide, polyvinyl butyrate, phenolic resins, maleic resins, starch or polyvinyl alcohol, amine resins, alkyd resins, epoxy resins, polytetrafluoroethylene, polyvinylidene fluorides, polyvinyl chloride or mixtures thereof, in particular water-soluble grades. The coatings can be powder coatings or water- or solvent-based coatings, with the choice of coating constituents being subject to the general knowledge of the person skilled in the art. Common polymeric binders for powder coatings are, for example, polyesters, epoxides, polyurethanes, acrylates or mixtures thereof.

In the case of plastics, all common plastics are suitable for incorporation of the moulded bodies according to the invention, for example thermosets or thermoplastics. The description of the possible applications and the plastics that can be employed, processing methods and additives are given, for example, in RD 472005 or in R. Glausch, M. Kieser, R. Maisch, G. Pfaff, J. Weitzel, Perlglanzpigmente [Pearlescent Pigments], Curt R. Vincentz Verlag, 1996, 83 ff., the disclosure content of which is incorporated herein.

Powder coatings, automobile paints and coatings for outdoor applications are particularly preferred since an increase in the abrasion stability is particularly advantageous in these applications. The increase in the abrasion stability has the consequence that the corresponding polymer matrices can be cleaned more frequently and intensively without significant abrasion of polymer and/or moulded body occurring. This is of major interest in particular in the case of pigments and very particularly preferably of flake-form pigments as moulded bodies according to the invention since the impression of the colour properties and/or lustre of the pigments is no longer impaired by the abrasion. This increased mechanical stability cannot be achieved by other methods without changing the essential properties of the polymer matrix.

It goes without saying that the moulded bodies according to the invention can also advantageously be used in the polymer matrices in mixtures with organic dyes and/or pigments, such as, for example, transparent and opaque white, coloured and black pigments, and with flake-form iron oxides, organic pigments, holographic pigments, LCPs (liquid crystal polymers) and conventional transparent, coloured and black lustre pigments based on metal oxide-coated flakes based on mica, glass, Fe₂O₃, SiO₂, etc. The moulded bodies according to the invention can be mixed in any ratio with commercially available pigments and fillers.

Fillers which may be mentioned are, for example, natural and synthetic mica, nylon powder, pure or filled melanin resins, talc, glasses, kaolin, oxides or hydroxides of magnesium, calcium, zinc, BiOCI, barium sulfate, calcium sulfate, calcium carbonate, magnesium carbonate, carbon, and physical or chemical combinations of these substances. There are no restrictions regarding the particle shape of the filler. It can be, for example, in flake form, spherical or needle-shaped in accordance with requirements.

The following examples are intended to explain the invention in greater detail, but without restricting it.

### EXAMPLES

### Example 1

(Samples 1 and 2)

150 g of mica are stirred at pH 5 into 1.9 l of water at 75° C. 181 g of AlCl₃ (sample 1) or 90.6 g of AlCl₃ (sample 2) are then slowly added as aqueous solution. The mixture is heated for a further 30 min., and the solid is filtered off and washed. After pre-drying, calcination is carried out at 950° C. for 45 min. The resultant aluminium oxide-coated, calcined sample is stirred into 1.6 l of water, and the mixture is warmed to 75° C. A solution of 5.1 g of ZnCl₂ in hydrochloric acid is slowly added with stirring, during which the pH is held at approximately 2. A titanium dioxide interference layer is then precipitated by slowly metering in a 40% solution of TiCl₄ in hydrochloric acid with stirring, with the interference colour of the moulded body being adjusted via the amount metered in. The mixture is neutralised, and the product is filtered off and washed. After pre-drying, the product is calcined at 850° C. for 30 minutes.

### Example 2

(Sample 3)

An Al₂0₃ moulded body is produced by the process described in WO 93/08237 and stirred in 1.6 l of water and warmed to 75° C. A hydrochloric acid solution of 5.1 g of ZnCl₂ is slowly added with stirring, during which the pH is held at approximately 2. A titanium dioxide interference layer is then precipitated by slowly metering in a 40% solution of TiCl₄ in hydrochloric acid with stirring, with the interference colour of the moulded body being adjusted via the amount metered in. The-mixture is neutralised, and the product is filtered off and washed. After pre-drying, the product is calcined at 850° C. for 30 minutes.

### Example 3

Moulded bodies according to Examples 1 and 2 according to the invention (sample 1; sample 2, sample 3) are applied at 60 kV in a concentration of 3% by weight into a commercially available polyester powder coating as dry blend. The abrasive loading is carried out using a Crockmeter and an abrasive cleaning agent (Ambruch 2 from Ambruch), with the resistance of the coating layer to the abrasive loading being assessed after 2500 strokes on the basis of the reduction in layer thickness that has occurred. The moulded bodies according to the invention are compared with a commercial pearlescent pigment (Iriodin® 103, Merck KGaA).

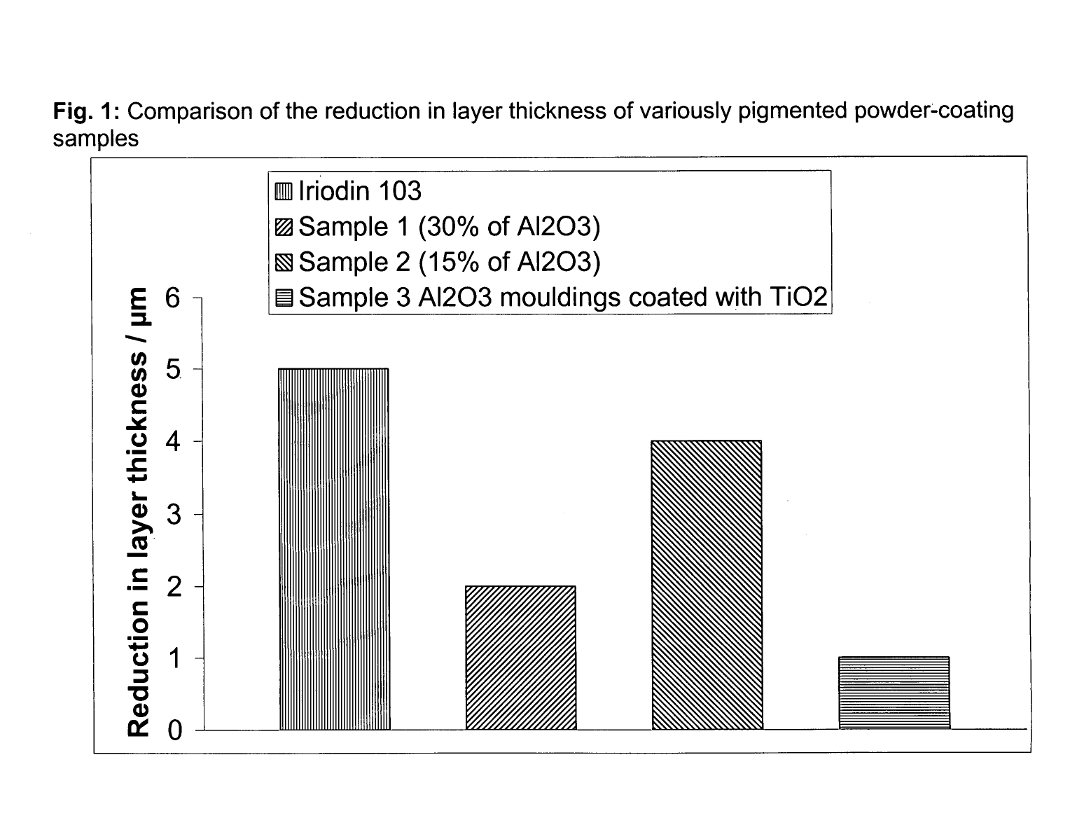

FIG. 1 shows the results after abrasive loading using the Crockmeter. It can be seen that the coating samples pigmented with the moulded bodies according to the invention (samples 1-3) have a smaller reduction in layer thickness compared with the commercial pearlescent pigment based on mica (Iriodin® 103). The visual impression essentially agrees with the reduction in layer thickness that has occurred, so that the mechanically stressed region of the mica-based commercial pearlescent pigment which has the greatest abrasion also appears visually to be degraded to the greatest extent.

1. Finely divided hard moulded body comprising materials having a hardness ≧7 on the Mohs hardness scale which form the moulded body or are present directly on a finely divided substrate as impermeable coating in the form of one or more layers.

2. Finely divided hard moulded body according to claim 1, characterised in that it is a pigment.

3. Finely divided hard moulded body according to claim 1, characterised in that the moulded body or the finely divided substrate is in flake form.

4. Finely divided hard moulded body according to claim 1, obtainable by wet-chemical application of a precursor to a support, drying, detachment from the support and subsequent calcination with formation of materials having a hardness ≧7 on the Mohs hardness scale or by application of materials having a hardness ≧7 on the Mohs hardness scale to a support by CVD and/or PVD processes and subsequent detachment from the support.

5. Finely divided hard moulded body according to claim 1, obtainable by wet-chemical precipitation of a primary layer comprising one or more layers on a finely divided substrate and subsequent calcination with formation of an impermeable coating in the form of one or more layers of materials having a hardness ≧7 on the Mohs hardness scale on the substrate or by single or repeated coating of a finely divided substrate with materials having a hardness ≧7 on the Mohs hardness scale by CVD and/or PVD processes.

6. Finely divided hard moulded body according to claim 1, characterised in that the finely divided substrate comprises natural or synthetic mica, metal flakes, glass flakes, SiO₂ flakes, TiO₂ flakes or iron oxide flakes.

7. Finely divided hard moulded body according to claim 6, characterised in that the metal flakes consist of aluminium, titanium, bronze, steel or silver.

8. Finely divided hard moulded body according to claim 1, characterised in that the material having a hardness ≧7 on the Mohs hardness scale comprises aluminium oxide, zirconium oxide and/or mixtures thereof.

9. Finely divided hard moulded body according to claim 1, characterised in that the thickness of the finely divided moulded body comprising a material having a hardness ≧7 on the Mohs hardness scale is 0.05 to 6 μm or the thickness of the coating applied to a finely divided substrate in the form of one or more layers of materials having a hardness ≧7 on the Mohs hardness scale is 40 to 400 nm.

10. Finely divided hard moulded body according to claim 1, characterised in that the finely divided moulded body has additionally been coated with one or more transparent, semi-transparent and/or opaque layers comprising metal oxides, metal oxide hydrates, metal suboxides, metals, metal fluorides, metal nitrides, metal oxynitrides or mixtures of these materials.

11. Finely divided hard moulded body according to claim 10, characterised in that a further layer of materials having a hardness ≧7 on the Mohs hardness scale has additionally been applied.

12. Finely divided hard moulded body according to claim 11, characterised in that the thickness of the further layer of a material having a hardness ≧7 on the Mohs hardness scale is 20 to 80 nm.

13. Process for the production of finely divided hard moulded bodies according to claim 1, characterised in that a moulded body is formed from materials having a hardness ≧7 on the Mohs hardness scale or a finely divided substrate is provided with an impermeable coating in the form of one or more layers of materials having a hardness ≧7 on the Mohs hardness scale.

14. Process according to claim 13, characterised in that a precursor is applied to a support by wet-chemical methods, dried, detached from the support and subsequently calcined with formation of a moulded body from materials having a hardness ≧7 on the Mohs hardness scale, or materials having a hardness ≧7 on the Mohs hardness scale are applied to a support by CVD and/or PVD processes and subsequently detached from the support.

15. Process according to claim 13, characterised in that a primary layer comprising one or more layers is precipitated onto a finely divided substrate by wet-chemical methods and calcined with formation of an impermeable coating in the form of one or more layers of materials having a hardness ≧7 on the Mohs hardness scale or a substrate is coated one or more times with materials having a hardness ≧7 on the Mohs hardness scale by CVD and/or PVD processes.

16. Process according to claim 13, characterised in that the material having a hardness ≧7 on the Mohs hardness scale comprises aluminium oxide, zirconium oxide and/or mixtures thereof.

17. Process according to claim 13, characterised in that the moulded body is additionally coated with one or more transparent, semi-transparent and/or opaque layers comprising metal oxides, metal oxide hydrates, metal suboxides, metals, metal fluorides, metal nitrides, metal oxynitrides or mixtures of these materials.

18. Process according to claim 17, characterised in that the one or more transparent, semi-transparent and/or opaque layers are applied by wet-chemical, sol-gel, CVD and/or PVD processes.

19. Process according to claim 17, characterised in that the applied transparent, semi-transparent and/or opaque layers are calcined.

20. Process according to claim 17, characterised in that a further layer of materials having a hardness ≧7 on the Mohs hardness scale is additionally applied.

21. Use of finely divided hard moulded bodies according to claim 1 in polymer matrices for increasing the abrasion stability.

22. Use according to claim 21, characterised in that the polymer matrices are plastics, paints, coatings or inks.

23. Abrasion-stable polymer matrices comprising finely divided hard moulded bodies according to claim 1.
